(19) United States
(12) Patent Application Publication
(10) Pub. No.: US 2005/0239514 A1
(43) Pub. Date: Oct. 27, 2005

(54) Telecom ring tone settings and properties method

(76) Inventor: Choei Chiu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/820,719

(22) Filed: Apr. 9, 2004

(51) Int. Cl. H04Q 7/20

(52) U.S. Cl. 455/567

(57) ABSTRACT

A method for setting telecom ring tones. A user registers with a common service platform or server. The common service server uploads the registration data to a home location register or local directory of registered users on a telecom switch or server. When the registered user makes a call or receives a call, the local directory verifies the user is registered. Then the telecom exchange connects to an added-service server. The added-service server processes the ring tone according to settings made by the user, so that the registered user or a caller calling the registered user hears the desired ring tone until the call is connected. The registered user can establish groups of callers so that appropriate ring tones are played for the suitable group. Additionally, priority can be set to pre-empt default tones according to the season, holiday, birthday, situation, or time.

### BACKGROUND OF THE INVENTION

1. Field of the Invention

The present invention relates to mobile telephones. More specifically, the present invention discloses a method for setting and modifying telephone ring tones and ring tone properties.

2. Description of the Prior Art

People typically relate to telephones when talking about telecommunications. However, due to advancements in technology, telephones have become multi-functional. Most consumers use telephone lines to link to the internet. Therefore, the distinguishing line between products is no longer clear. Using currency as standard, the market for accessories and services developed for telecommunications has reached trillions of dollars. In such a huge market, companies are struggling to develop new products in order to reach all segments of the market. As the market becomes saturated, companies should begin focusing on the future.

Telecommunication has exists for more than 100 years. Prior to this, humans used firelight, bulbs and mirror reflections to try to achieve the dream of distant communication. Samuel Morse invented the telegraph for distant communication in 1835, and the first telegraph line was connected from Washington D.C. to Baltimore in that year. The content of the first telegram, “What hath God Wrought?” was thought to be a good question for telecommunication. After 100 years, telecommunication has spread through all countries, and has shortened the distance between people.

Inspecting the history of telecommunication helps us plan for the future. Western Union was established in 1850 in Rochester, N.Y. Their aim was to use coding to transmit messages from point A to point B. The transmission content was controlled by man, but could only function on a public network that could receive messages. On Mar. 10^{th}, 1873, Alexander Graham Bell invented something that has changed our way of life, the telephone. The telephone was exhibited at the World Expo in 1876. In 1877, Bell Telephone Company was established and started to mass-produce telephones.

Telephones have become so popular that having more than one phone number is common. Refer to FIG. 1, which is a diagram for making a phone call. As shown in FIG. 1, the user 10 uses telecom equipment through a telecom switch 20 to call a person 30. Before the call is connected, the user 10 receives a waiting tone, which is a mechanical tone, sounding like doo doo. However, the universal and basic nature of the tone has become boring to most telephone users. Furthermore, it is not possible for the user to customize the waiting tone. As users become more sophisticated, they demand products that are more customizable, useful, and personal.

Therefore, the present invention provides a method for setting and modifying telecom ring tones, settings, and properties, that allows users to individually set personalized ring tones for different callers, times, and situations.

### SUMMARY OF THE INVENTION

To achieve these and other advantages and in order to overcome the disadvantages of the conventional method in accordance with the purpose of the invention as embodied and broadly described herein, the present invention provides a method for setting and modifying telecom ring tones, settings, and properties, that allows users to individually set personalized ring tones for different callers, times, and situations. These personalized ring tones comprise ring tones, ring back tones, call waiting tones, call forward tones, and call holding tones.

An object of the present invention is to provide a method for setting telecom ring tones and properties. A home location register or local directory in the telecom switch judges whether the user is a registered user of the personalized ring tones service. If the user is registered, they are connected to an added-service server or service center to proceed with replacing or modifying the ring tone. At the same time, according to the user settings, the home location register or local directory also allows the user or the people who call the user to hear the audio data that has been set or selected by the user. The audio data is, for example, music, a recording, or dialogue. The audio data can also been modified according to the season, for festivals, by time, or situation, in order to enhance the personalized nature of the telephone usage experience.

Another object of the present invention is to provide a method of setting ring tone settings. By installing a common service platform, users can register at the common service server or center. After registering, the user data is stored in the home location register or local directory in the telecom switch. Additionally, connecting to an added-service server or center provides a built-in or plug-in audio database, in order to allow users to proceed with selecting or modifying ring tone settings.

Another object of the present invention is to provide a method of setting group ring tone properties. By accessing the added-service server or center the user can set groups of telephone numbers to be associated as a group on the added-service server, so that when a member of the group calls the user, the selected group ring tone is used.

The present invention discloses a method of selecting or modifying telecom ring tone settings and properties. The user connects to a common service server to register, and then the common service server transmits the registration data to be uploaded to the home location register in the telecom switch. The user also connects to an added-service server to set groups of phone numbers to be associated as a group, as well as selecting the audio data as the ring tone replacement in the built-in or plug-in audio database on the added-service server. By doing so, when the user calls the group or when any of the members in the group contacts the user, the home location register judges whether this call relates to the registered user according to the built-in database; and then connects to the added-service server to process the audio data set by the user.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram showing a conventional telephone call procedure;

FIG. 2 is a flowchart illustrating a method for listening to replaced ring tones according to an embodiment of the present invention;

FIG. 3 is a flowchart illustrating a method for registering using the internet, world wide web, or wireless application protocol (WAP) according to an embodiment of the present invention;

FIG. 4 is a flowchart illustrating a method for registering using telecom equipment according to an embodiment of the present invention;

FIG. 5 is a block diagram illustrating a method for setting ring tone properties according to an embodiment of the present invention;

FIG. 6A is a block diagram illustrating a method for registering using the internet, world wide web, or wireless application protocol (WAP) according to an embodiment of the present invention;

FIG. 6B is a block diagram illustrating a method for registering using telecom equipment according to an embodiment of the present invention; and

FIG. 7 is a diagram illustrating application of the added-service server according to an embodiment of the present invention.

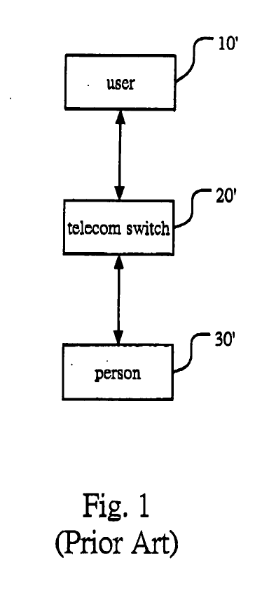

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The present invention solves the problem of a boring or impersonal ring tone, like a mechanical tone, that rings when calling someone before the call is connected. Therefore, by installing an added-service server of the present invention, whether the user calls someone or someone calls the user, they call listen to special personalized audio data before the line is connected. The audio data is, for example, music or dialogue and can be set according to the season, holiday, time, or situation. For example, personalized ring tones can be selected for holidays such as Christmas, for wedding anniversaries, birthdays etc. The user can also record audio data, so that the waiting tone can reveal a personal flair or style which is more interesting.

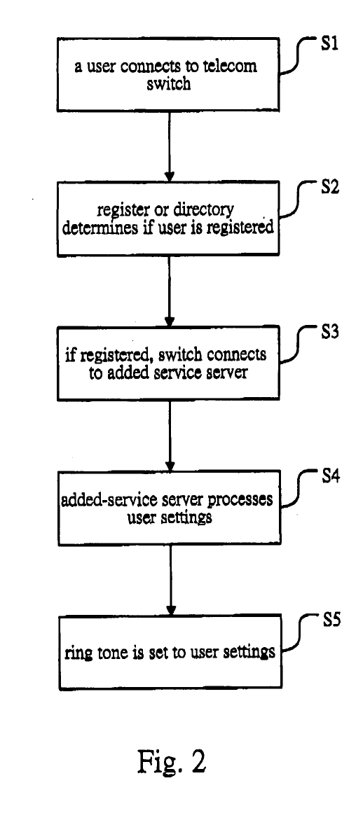

Refer to FIG. 2, which is a flowchart illustrating a method for listening to replaced ring tones according to an embodiment of the present invention. As shown in the figure:

In step 1 S1, a user connects to a telecom switch. In step 2 S2, the home location register or local directory in the telecom switch determines whether the user is a registered user. If the user is a registered user, in step 3 S3, the telecom switch connects to the added-service server. Then, in step 4 S4, the added-service server processes the user settings. Finally, in step 5 S5, the ring tone that rings before the call is connected is replaced by the audio data and ring tone properties set by the user.

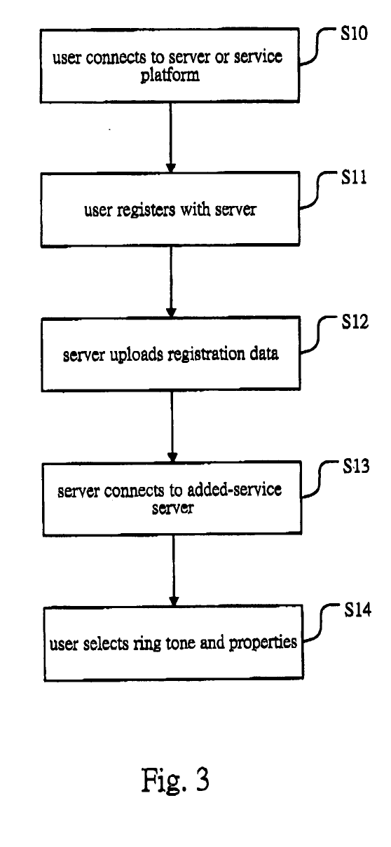

In step 1 S1, before the user uses the added-service, the user needs to register with the service. Refer to FIG. 3, which is a flowchart illustrating a method for registering using the internet, world wide web, or wireless application protocol (WAP) according to an embodiment of the present invention. As shown in the Figure:

In step 10 S10, a user connects to a common service server or common service platform. In step 11 S11, the user registers with the common service server. Then, in step 12 S12, the common service server uploads the registration data to the home location register or local directory in the telecom switch. In step 13 S13, the common service server connects to an added-service server. Finally, in step 14 S14, the user can select, set, or modify the ring tone and ring tone properties.

In the method illustrated in FIG. 3, the user registers using the internet, world wide web, or wireless application protocol (WAP). However, the user can also register using a telephone or telecom equipment.

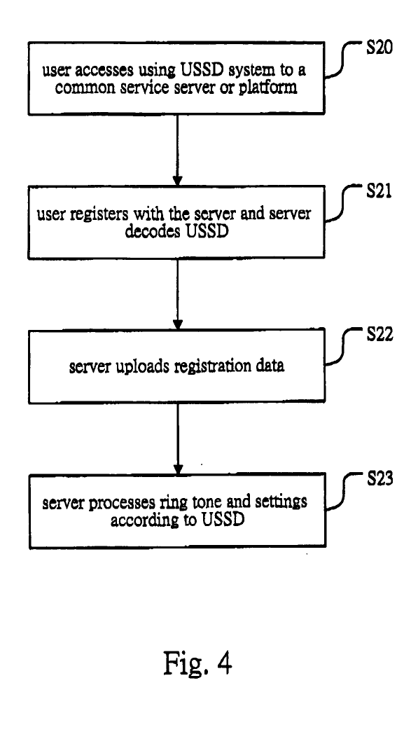

Refer to FIG. 4, which is a flowchart illustrating a method for registering using telecom equipment according to an embodiment of the present invention. As shown in the figure:

In step 20 S20, the user accesses equipment with an Unstructured Supplementary Service Data (USSD) system, and sends the USSD to a common service server or common service platform. In step 21 S21, the user registers with the common service server, and then the common service server decodes the USSD in order to process the registration.

In step 22 S22, the common service server uploads the registration data to the home location register or local directory in the telecom switch. Then, in step 23 S23, the common service server processes the ring tone and ring tone settings according to the USSD.

The user can use a telecom network to connect to the common service server. The network can be a public telecom network, a cable network, a radio network, a satellite network, an optical cable network, or a cable TV network. The common service server also connects to the added-service server via a telecom network. The user can process the related settings on the added-service server. The related settings are for example, the groups or group settings set by the user when making calls, and the replacement ring tone or audio data. Therefore, when calling the user, the caller can hear the ring tone set by the user. Alternatively, the common service server contains an audio database to be used as selections for the user. The common service server can also connect to an external audio database. The common service server also connects to the external audio database via an information network or telecom network.

Furthermore, in step S1, the user can also connect to the telecom switch via a public telecom network, a cable network, a radio network, a satellite network, an optical cable network, a computer network or a cable TV network. The audio data set by the user can be music, a dialogue, or can be replaced according to the season, holiday, situation, or time.

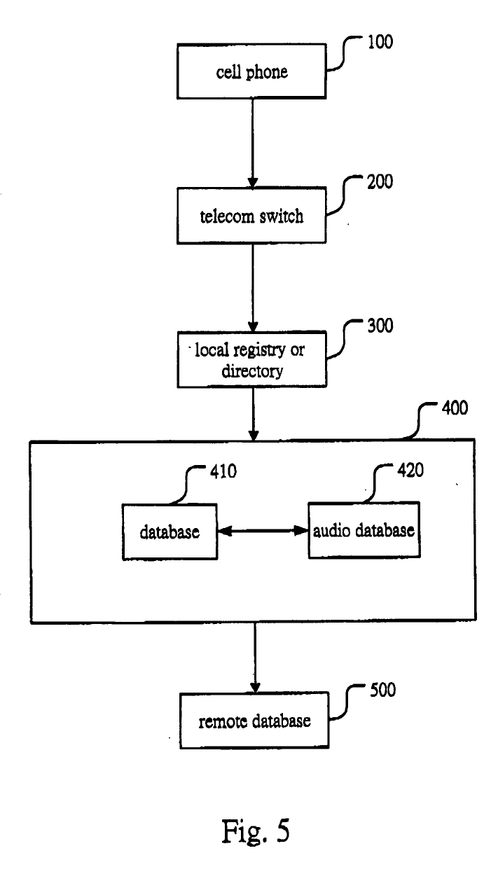

Refer to FIG. 5, which is a block diagram illustrating a method for setting ring tone properties according to an embodiment of the present invention.

As shown in the diagram, a cell phone 100 connects to a telecom switch 200. The telecom switch 200 uses the home location register or local directory 300 to determine if the user is a registered user. If the cell phone 100 is a registered user, the user is connected to an added-service server 400. The groupings and related settings can be processed in the database 410 on the added-service server 400. For groups there are multiple phone numbers in one group. For example, a user may establish one group as a customer group comprising the associated data for the user's customers. When any of the customers in the customer group call the user, the customer will hear a ring tone that has been personally selected by the user. In this example, an appropriate ring tone may be audio data comprising an advertisement for the user's products or services or the user's company name. The user also establishes a group for the user's co-workers. When any of the user's co-workers call the user, they will hear an appropriate ring tone for their group. Since they belong to the same company, a ring tone comprising a company advertisement may not be the best choice. Therefore, the user can select a ring tone that is more appropriate for his co-worker group.

In another example, the user is a teenage student. In this example, the student can select different ring tones for various groups such as classmates, friends, family, or teachers. Obviously, the same ring tone is not appropriate for all of these groups. Therefore, the student can select a ring tone comprising popular music for his friends and a more subtle ring tone for his family. In this way, the user can personalize their telecom experience and tailor it to match their personality.

Related settings are, for example, audio message settings. The database 410 is also connected to an audio database 420. The audio database can also be an external or remote database 500. With the above installation, the user 100 can provide, according to the settings in the database 410 in the added-service server, a suitable ring tone to be used when making a call to the groups and when members of the group call the user. This enhances the individualism of the user and more closely reflects the user's personality.

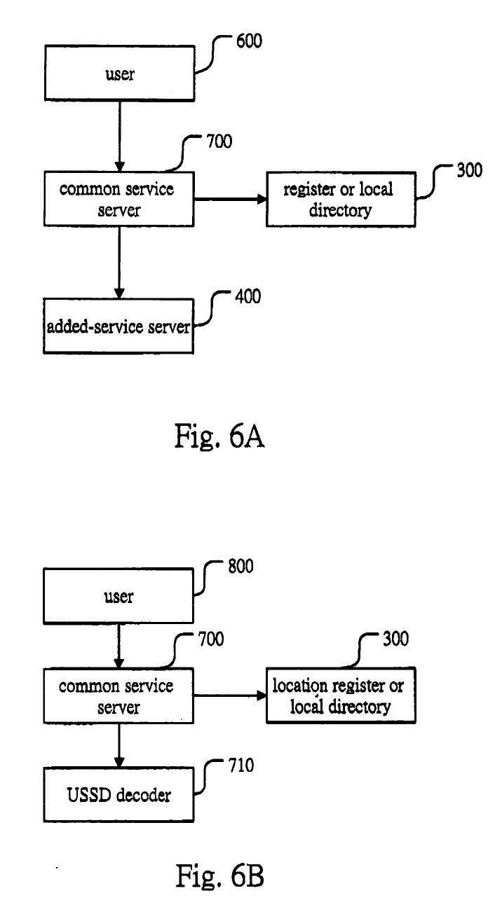

As described above, before the user is able to modify the ring tone settings, the user needs to register. Refer to FIG. 6A, which is a block diagram illustrating a method for registering using the internet, world wide web, or wireless application protocol (WAP) according to an embodiment of the present invention.

As shown in the figure, the user uses the web or WAP to register directly via the network or internet. The user 600 connects to a common service server 700 to register. The common service server 700 uploads the registration data to the home location register or local directory 300. When the user 600 makes a call, the home location register or local directory 300 determines whether the user is a registered user. If the user is registered, the common service server 700 connects to an added-service server 400. The user 600 can process the related settings, for example, setting up groups or selecting ring tones on the added-service server 600.

Alternatively, the user can use telecom equipment to register. Refer to FIG. 6B, which is a block diagram illustrating a method for registering using telecom equipment according to an embodiment of the present invention.

As shown in the figure, the user uses a telecom device 800, for example a mobile telephone, to connect to a common service server 700 in order to register. The common service server 700 uploads the registration data to a home location register or local directory 300. When the user makes a call, the home location register or local directory 300 determines whether the user is registered. If registered, the user can process the related settings in the common service server 700, such as setting groups and the replaced ring tone. Importantly, there is a USSD decoder 710 in the common service server 700, in order to decode USSD transmitted from the telecom device 800.

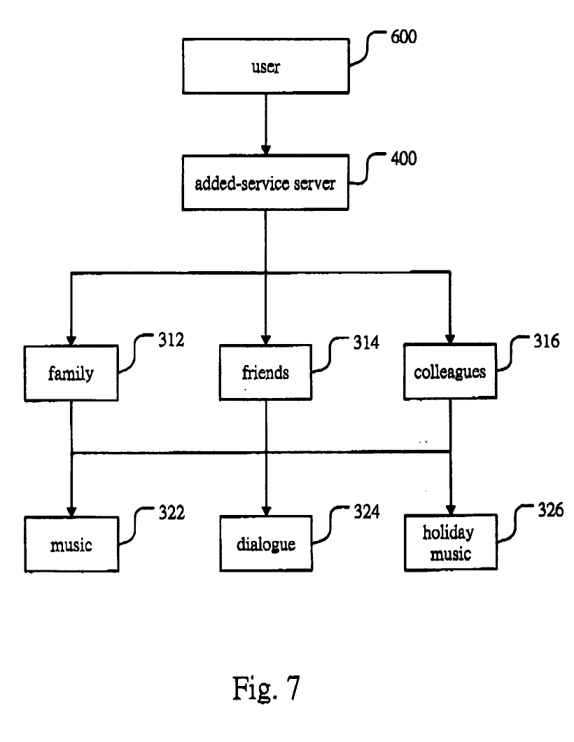

Refer to FIG. 7, which is a diagram illustrating application of the added-service server according to an embodiment of the present invention. As shown in the diagram, when a user 600 connects to an added-service server 400, the groups can be categorized into, for example, family 312, friends 314 and colleagues 316, and the ring tones can be set as, for example, music 322, dialogue 324 or holiday music 326.

According to the user settings, the ring tone for the friends group can be set as holiday music 326 during the holiday period, for example. The user has many options for setting the properties. Alternatively, when the user 600 calls the friends group 314 and before the call is connected, the ring tone can be set as music 322. At the same time, when a person of the friends group 314 calls the user 600, the ring tone can also be music 322. In short, no matter whether the user makes or receives a call, the user can set the ring tones according to their wishes.

In addition to the basic settings as described above, advanced services and settings are also provided by embodiments of the present invention. For example, a user has a friend whose birthday is July 1. The user has set up the friend as a member of the user's friend group. When the friend calls the user, the friend hears popular music as a ring tone. However, when the friend calls on July 1, the friend hears Happy Birthday as a ring tone. Furthermore, during the holiday period, when the friend calls, the friend hears holiday music as a ring tone. The user can establish a priority in the system so that different events result in different ring tones or ring tone properties.

An advantage of the present invention is that the user can upload data from a contact or personal database. In this way, the user's contact database that is maintained on the user's computer, PDA, or telephone can easily be modified and uploaded to the server. As a result, complex interconnections and relationships can be established easily. In this embodiment, contacts can belong to several groups, and a priority can be set depending on, for example, contact, company, relationship, time, situation, season, etc.

For example, when a user goes on holiday, the user can set a ring tone comprising an “on-leave” notice for some groups. However, the user can prioritize the ring tone audio data type so that certain criteria allows other ring tones to take priority over the default ring tone. In this case, if a friend calls on their birthday, the birthday greeting ring tone will take priority over the “on-leave” notice ring tone.

In other applications of embodiments of the present invention, the ring tone can be prioritized according to time. For example, if a customer calls the user during the working hours, the customer may hear an advertisement for the user's company. However, if the customer calls after working hours, the customer hears a message indicating that it is outside of working hours. Furthermore, if the customer is associated as an elite customer, the customer may hear a ring tone comprising the user's home telephone number. In this way, the customer can still belong to a main group of customers but can have special properties associated with them. This allows easier management of the group and group settings.

In another embodiment of the present invention, the ring tones are not directly controlled by the user. For example, the user can choose to have the added-service system control the ring tones via the audio database. In this example, when a friend calls the user, the friend will hear a ring tone comprising, for example, a random ring tone, or one of the top ten popular songs of the week. This allows the user to enjoy a more diverse experience without requiring the user to constantly update the ring tone settings.

Alternatively, the ring tones can be controlled by an external audio database. In this example, the user chooses to allow third-party vendors to provide ring tones comprising, for example, advertisements, news, movie info, etc. In this way, the costs associated with the personalized ring tone service can be shared or paid for by the third-party, thus lowering the telecom service charges to the user.

For purposes such as advertising, the service provide can choose to allow non-registered users to hear demonstrations, previews, or advertisements for the ring tone service. In this way, users that haven't registered can be made away of the service or benefits of the service. This can increase the service providers revenue.

Another advantage to increase the benefit to registered users is the user can select a flashcard mode. In this service option, the registered user hears random messages within an established area or subject while making a call. This embodiment is particularly useful for learning, for example, language learning. The user is studying a language, for example, English. After choosing the English learning option, every time the registered user makes a call, a new word or phrase with translation or definition is played as a ring tone. In this way, the educational use of the ring tone service is enhanced for the user.

Alternatively, a “to do” list, reminder, or appointment schedule is played as a ring tone. Furthermore, a ring tone comprising a time or date that the user called the number is played. This acts as a reminder for the user as a reference to know when the last contact was made.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

1. A telecom ring tone method, comprising:
a user connects to a telecom switch;
a home location register in the telecom switch verifies a caller is a registered user;
if the caller is registered, the telecom switch connects to an added-service server;
the added-service server processes settings for the registered user; and
when a call is made and before the call is connected a ring tone according to the registered user's settings is played.

2. The method of claim 1, further comprising:
a user connects to a common service server;
the user registers with the common service server;
the common service server uploads registration data to the home location register in the telecom switch;
the common service server connects to the added-service server; and
the user selects a desired ring tone and related ring tone properties in the added-service server.

3. The method of claim 2, whereby the user connects to the common service server via a telecom network.

4. The method of claim 3, whereby the telecom network comprises a public telecom network, a cable network, a radio network, a satellite network, an optical cable network, or a cable television network.

5. The method of claim 3, whereby the common service server connects to the added-service server via a telecom network, a network, a computer network, or an internet.

6. The method of claim 2, whereby the related ring tone properties comprise group settings, priority settings, advanced services settings, random tone settings, third-party vendor settings, and service control settings.

7. The method of claim 6, whereby the group settings comprise a group type and a list of members of a group.

8. The method of claim 7, whereby when a member of a group calls the registered user or the registered user calls a member of the group, the desired ring tone is played.

9. The method of claim 3, whereby the added-service server comprises an audio database of ring tones from which the registered user can select desired ring tones.

10. The method of claim 2, whereby the desired ring tone comprises music, dialogue, advertising, holiday music, audio data, and audio data recorded by the registered user.

11. A telecom ring tone method, comprising:
registering and setting up, comprising;
a user connects to a common service server;
the user registers with the common service server;
the common service server uploads registration data to a home location register in a telecom switch;
the common service server connects to the added-service server;
the user selects a desired ring tone and related ring tone properties in the added-service server; and
applying, comprising;
the user places a call or receives a call;
the home location register in the telecom switch verifies the user is a registered user;
for registered users, the telecom switch connects to the added-service server;
the added-service server processes settings selected by the registered user; and
the desired ring tone according to the related ring tone properties is played for the registered user or a caller to the registered user, until the call is connected.

12. The method of claim 11, whereby the user connects to the common service server via a telecom network.

13. The method of claim 12, whereby the telecom network comprises a public telecom network, a cable network, a radio network, a satellite network, an optical cable network, or a cable television network.

14. The method of claim 11, whereby the common service server connects to the added-service server via a telecom network, a network, a computer network, or an internet.

15. The method of claim 11, whereby the related ring tone properties comprise group settings, priority settings, advanced services settings, random tone settings, third-party vendor settings, and service control settings.

16. The method of claim 15, whereby the group settings comprise a group type and a list of members of a group.

17. The method of claim 16, whereby when a member of a group calls the registered user or the registered user calls a member of the group, the desired ring tone is played.

18. The method of claim 11, whereby the added-service server comprises an audio database of ring tones from which the registered user can select desired ring tones.

19. The method of claim 11, whereby the desired ring tone comprises music, dialogue, advertising, holiday music, audio data, and audio data recorded by the registered user.
